(19) United States
(12) Patent Application Publication
(10) Pub. No.: US 2026/0288554 A1
(43) Pub. Date: Sep. 24, 2026

(54) ONLINE REMAINING LIFE PREDICTION METHOD FOR ELECTRONIC DEVICES UNDER FIELD OPERATING CONDITIONS

(71) Applicant: Xi'an Synaptictek Information Technology Co., Ltd., Xi’an (CN)

(72) Inventors: Shuai Zhao, Xi'an City (CN); Jian Gao, Xi'an City (CN); Shaowei Chen, Xi'an City (CN); Meng Gao, Xi'an City (CN); Shiyin Wang, Xi'an City (CN)

(21) Appl. No.: 19/255,569

(22) Filed: Jun. 30, 2025

(30) Foreign Application Priority Data
Mar. 20, 2025 (CN) 202510330006.3

(51) Int. Cl. G06F 11/00

(52) U.S. Cl. CPC G06F 11/008; G06F 11/004; G06F 2201/81

(57) ABSTRACT

This application discloses an online remaining useful life prediction method, system, storage medium, and electronic device for electronic device under filed operating conditions. A Gamma state-space model is constructed, and initial parameter estimates of the model are obtained using the Expectation-Maximization algorithm. Based on the initial parameter estimates and real-time monitoring data collected from field-operated devices, the true health state of the devices is dynamically updated using a kernel-smoothed particle filter. The EM algorithm is then used again to estimate updated parameters of the Gamma state-space model, yielding the final model. The remaining useful life is subsequently calculated. This application first extracts degradation information and establishes an initial degradation model based on accelerated degradation testing data, and then combines it with field operation data to dynamically update the degradation information and model parameters using the particle filter with kernel smoothing, thereby enabling real-time RUL prediction under filed operating conditions.

### PRIORITY

This application claims priority to Chinese Patent Application Serial No. 202510330006.3, filed Mar. 20, 2025, entitled “An Online Remaining Life Prediction Method for Electronic Devices under Field Operating Conditions,” the entire disclosure of which is incorporated herein by reference.

### TECHNICAL FIELD

The present application relates to the field of device reliability assessment, particularly to an online prediction method, system, storage medium, and electronic device for the remaining useful life of electronic devices under operating conditions.

### BACKGROUND

The data-driven RUL prediction methods for electronic devices rely on accelerated degradation data. Accelerated degradation testing, as an effective experimental method, is widely used to obtain degradation datasets for electronic devices with high reliability and long lifetime. However, since accelerated degradation experiments subject electronic devices to extreme conditions that are far from the actual operating conditions of the devices, the results obtained in the laboratory often differ significantly from those found in field failure analysis. Therefore, it is of great importance to study RUL prediction methods under field operating conditions and conduct field reliability analysis.

Through a review of the current literature, it is found that most existing RUL prediction techniques for electronic devices do not combine degradation test data with real-time monitoring data. One existing RUL prediction method mainly uses the state monitoring data of the tested device before the prediction time point to identify the model parameters, and then predicts the RUL based on the estimated model parameters. These methods do not fully utilize the experimental test data. For example, Chen and others developed an RUL prediction method that integrates a fractional gray model and an unscented particle filter. This method uses data before different prediction start points and employs an adaptive mutation particle swarm optimizer to update the model parameters. Ahwiadi and others proposed an enhanced particle filtering technique to improve the health state monitoring and RUL prediction accuracy of batteries. During training, the method uses limited state monitoring data from a single battery to identify the particle filtering model, and during prediction, the identified model is used for RUL prediction. The flaw of these methods is that they only utilize the limited state monitoring data of the tested device, while neglecting the abundant information contained in the accelerated degradation test datasets.

Another existing RUL prediction method entirely relies on historical test degradation datasets, including those based on traditional support vector regression and neural network methods. These methods learn network or model parameters from offline test datasets and then directly apply them to field operation datasets. However, since the training datasets are usually obtained from accelerated degradation tests, and the operating conditions of the test datasets are relatively mild, it is difficult to guarantee that the operating conditions of the training and test datasets are the same, which limits the application of the above methods.

The common feature of these two types of methods is that they do not combine degradation test data with real-time monitoring data, and only utilize one source of data. This leads to the inability to apply the prediction methods to devices operating in the field, or when applied to field devices, the RUL prediction lacks accuracy.

### BRIEF DESCRIPTION OF THE DRAWINGS

FIG. 1 is a flowchart of the method provided by an embodiment of the present application;

FIG. 2 is an implementation framework diagram provided by an embodiment of the present application;

FIG. 3 is a degradation trajectory diagram of the IGBT device provided by an embodiment of the present application;

FIG. 4 is the parameter convergence process during the offline parameter estimation phase provided by an embodiment of the present application;

FIG. 5 is the predicted trajectory of Sample 1 at different time points provided by an embodiment of the present application;

FIG. 6 is the predicted trajectory of Sample 3 at different time points provided by an embodiment of the present application;

FIG. 7 shows the RUL prediction results of eight devices at 80% of their life cycle provided by an embodiment of the present application;

FIG. 8 shows the prediction errors and 95% confidence intervals of different devices from start-up to failure time points provided by an embodiment of the present application;

FIG. 9 is the system framework diagram provided by an embodiment of the present application.

The realization, functional characteristics, and advantages of the present application will be further described in conjunction with the embodiments and with reference to the accompanying drawings.

### INVENTION DESCRIPTION

The main objective of this application is to provide a method, system, storage medium, and electronic device for online RUL prediction of electronic devices under operating conditions. The goal is to propose a method that not only fully utilizes historical datasets but also adapts the model using real-time monitoring data of field-operated devices, making it applicable to those devices.

To achieve the above objectives, the first aspect of this application provides a method for online RUL prediction of electronic devices under field operating conditions, which includes the following steps: In the offline phase, a Gamma random process is used to model the degradation process of the electronic device, with the physical prior model embedded as the shape parameter into the Gamma random process, resulting in a Gamma state-space model. The EM algorithm is employed to process pre-acquired accelerated degradation experimental data, obtaining an initial model with parameter estimates. In the online phase, real-time monitoring data of field-operated devices are input into the state and parameter joint estimation algorithm based on kernel-smoothing particle filtering, resulting in dynamically updated accelerated degradation information and parameters of the device's initial model. Based on the updated model, the randomized failure threshold distribution, and the accelerated degradation information, the RUL of each electronic device is calculated.

Optionally, in the offline phase, the Gamma random process is used to model the degradation process of the electronic device, embedding the physical prior model as the shape parameter into the Gamma random process to obtain a Gamma state-space model. This includes acquiring the PDF of the Gamma random process, where the PDF consists of shape parameters, scale parameters, and measurement noise parameters, with the shape parameter reflecting degradation state increments. These increments are represented as random variables related to the device, yielding the device-specific PDF, and based on this PDF, the true degradation state of the device is determined. The true degradation state of each device is then used, along with Gaussian noise, to determine the corresponding Gamma state-space model for each device.

Optionally, the EM algorithm is used to process the pre-acquired accelerated degradation experimental dataset, obtaining the initial model with parameter estimates, including: determining unknown parameters to be estimated based on the Gamma state-space model for each device, where the unknown parameters include state transition model parameters and noise parameters; executing particle filtering and smoothing algorithms on the historical degradation measurement dataset to obtain a smoothed particle set; determining the log-likelihood function of the unknown parameters based on the smoothed particle set, and estimating the unknown parameters based on the expectation of the log-likelihood function to obtain the initial model with parameter estimates.

Optionally, in the state and parameter joint estimation algorithm based on kernel-smoothing particle filtering, real-time monitoring data from field devices are input to obtain dynamically updated accelerated degradation information and the device's initial model parameters. This includes: taking any moment's parameter particle vector as a parameter particle; applying kernel-smoothing particle filtering to shrink the parameter particles toward the mean, obtaining the first particle parameters; adding random noise to the first particle parameters to obtain second particle parameters; updating the particle parameters based on both the first and second particle parameters; generating true health state data for each device based on the real-time monitoring data and the updated particle parameters; and using the EM algorithm to process the true health state data to obtain the updated initial model parameters, which are then used to process the real health state data, obtaining the accelerated degradation information.

Optionally, based on the mean particle parameters and diversity particle parameters, the updated particle parameters are obtained, including: determining the expression of the parameter state transition equation based on the first and second particle parameter expressions; calculating the updated particle parameters based on the expression of the parameter state transition equation.

Optionally, based on the final updated model, randomized failure threshold distribution, and accelerated degradation information, the RUL of each electronic device is calculated, including: determining the marginal survival function for each device based on the updated initial model; approximating the marginal survival function using the Gauss-Hermite quadrature method to obtain the lifetime probability density function of the device under the current degradation state; and using the lifetime probability density function, the current accelerated degradation information, and the randomized failure threshold to calculate the RUL of each device.

Optionally, based on the updated model, the marginal survival function of each electronic device is determined, including: determining the PDF of the shape parameter degradation increment under the updated initial model's parameter conditions, where this probability density function is a function of the failure threshold; determining the survival function of each device driven by the Gamma process based on the probability density function of the shape parameter degradation increment; integrating the survival function over the failure threshold to obtain the marginal survival function for each device.

The second aspect of this application provides an online RUL prediction system for electronic devices under field operating conditions, which includes: an offline parameter estimation module, which, in the offline phase, uses a Gamma random process to model the degradation process of the electronic device, with the physical prior model embedded as the shape parameter, resulting in a Gamma state-space model. The EM algorithm is used to process pre-acquired accelerated degradation data, obtaining the initial model with parameter estimates; an online parameter update module, which in the online phase, inputs real-time monitoring data from field-operated devices into the state and parameter joint estimation algorithm based on kernel-smoothing particle filtering, obtaining dynamically updated accelerated degradation information and parameters of the initial model; and a lifetime estimation module, which calculates the RUL of each electronic device based on the updated initial model, randomized failure threshold distribution, and accelerated degradation information.

The third aspect of this application provides a computer-readable storage medium that includes instructions, which, when executed on a computer, cause the computer to perform the method for online RUL prediction of electronic devices under field operating conditions provided in the first aspect.

The fourth aspect of this application provides an electronic device, which includes at least one processor, memory, and input/output units. The memory stores a computer program, and the processor calls the computer program stored in the memory to execute the online RUL prediction method of electronic devices under field operating conditions as specified in any of the claims 1-7.

The method, system, storage medium, and electronic device for online RUL prediction of electronic devices under operating conditions, as presented in this application, model the degradation process of electronic devices using a Gamma random process, resulting in a Gamma state-space model. The shape parameter of this model is the physical prior model, and the EM algorithm is employed to process pre-acquired accelerated degradation experimental data to estimate initial parameters. Real-time monitoring data from field devices are used to dynamically update the device's true health state using the kernel-smoothing particle filtering algorithm. Based on this true health state, the EM algorithm is used to determine the new parameter estimates of the Gamma state-space model, resulting in the final model. Using the final model, the randomized failure threshold distribution, and the true health state, the RUL of each device is calculated. This method accurately estimates the initial model parameters using accelerated failure experimental data, extracts degradation information, and establishes an initial degradation model. It then dynamically updates the degradation information and model parameters based on real-time field data, enabling real-time life prediction under operating conditions. This approach combines the advantages of both accelerated failure experimental data and real-time field data, enhancing prediction accuracy, reliability, and applicability in engineering.

### DETAILED DESCRIPTION OF EMBODIMENTS

It should be understood that the specific embodiments described here are for explanatory purposes only and are not intended to limit the scope of the application.

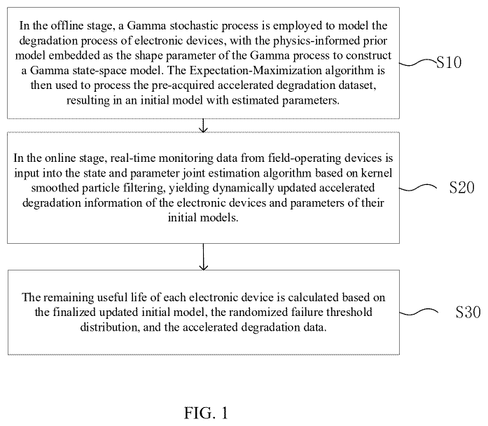

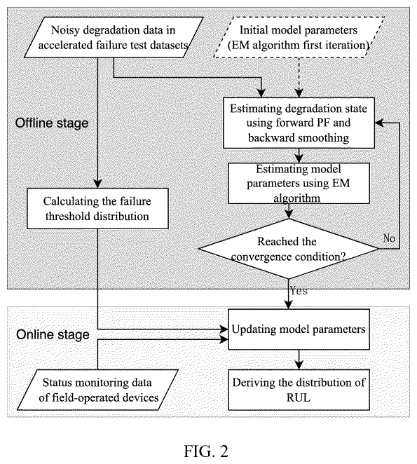

Referring to FIGS. 1 and 2, the first embodiment of this application provides a method for online prediction of the RUL of electronic devices under field operating conditions. This method can be executed by the processor of a terminal or server. The method for online prediction of the remaining useful life of electronic devices under field operating conditions includes the following steps:

S10. Offline stage: Model the degradation process of the electronic device using a Gamma random process, and embed a physical prior model as a shape parameter into the Gamma random process to obtain a Gamma state-space model. Use the EM algorithm to process the pre-obtained accelerated degradation experimental dataset and obtain the initial model after parameter estimation.

S20. Online stage: Input real-time monitoring data of field operating devices into the state and parameter joint estimation algorithm of kernel smoothing particle filtering to obtain dynamically updated accelerated degradation information of the electronic device and the parameters of the initial model of the electronic device.

S30. Based on the final updated model, randomized failure threshold distribution, and accelerated degradation information, calculate the RUL of each electronic device.

This application includes both offline and online processes. In the offline process, use the accelerated failure experimental dataset to estimate the degradation model parameters, and the obtained model describes the degradation characteristics of the device population in the dataset. In the online process, continuously update the model parameters based on the real-time monitoring data of field operating devices, customizing the model to accurately describe the degradation process of the test device.

In this embodiment, this application addresses the issue of model adaptability from the accelerated failure experimental environment to the field operating environment. It models the degradation process of the device using a Gamma process and incorporates a physical prior model as the shape parameter in the Gamma process model. Based on accelerated failure experimental data, the EM algorithm is used to estimate the initial model parameters, extract degradation information from the accelerated failure dataset, and establish the initial degradation model. Based on field operation data, the kernel smoothing particle filtering algorithm is used to extract degradation information from field operating devices and update the model parameters. This application fully utilizes both accelerated failure experimental data and field operation data to achieve online prediction of the RUL of electronic devices under field operating conditions, effectively solving the problem of model adaptability from the accelerated failure experimental environment to the field operating environment. The application theoretically enhances the physical interpretability and applicability of the model. In terms of method implementation, it realizes real-time life prediction under field operating conditions. This method fully combines the advantages of accelerated failure experimental data and field operation data, not only improving the accuracy and reliability of life prediction but also enhancing the applicability and engineering practicality of the method.

In the embodiment of this application, step S10 includes the following specific execution processes:

S101. Obtain the PDF of the Gamma random process, where the PDF includes shape parameters, scale parameters, and measurement noise parameters, and the shape parameters have degradation state increments.

S102. Represent the degradation state increment as a random variable related to the device individual, obtain the PDF of the device individual, and determine the true degradation state of the electronic device based on the PDF of the device individual.

S103. Based on the true degradation state of each electronic device after adding Gaussian noise, determine the Gamma state-space model for each electronic device.

The processor implements the offline model building through steps S101 to S103.

This application first constructs an offline model for the degradation process. Specifically, in the degradation process of electronic devices, their health state deteriorates over time. Therefore, the change in health state of the device is considered monotonic, which reflects the irreversible performance loss or functional degradation of the electronic device during long-term use. To fully account for this inherent monotonicity, a Gamma stochastic process is used to model the degradation process of the device. According to the definition of the Gamma stochastic process, the PDF of the health state x(t) can be expressed as:

$$f ( x ( t ) ; v ( t ) , u ) = \frac{1}{uG ( v ( t ) )} {( \frac{x ( t )}{u} )}^{v ( t ) - 1} exp ( - \frac{x ( t )}{u} ) \qquad ( 1 )$$

Among them, x(t) represents the health state, x(t), v(t) and u are the shape and scale parameters of the Gamma distribution, and

$$G ( a ) = {\int }_{z = 0}^{∞} {z}^{a - 1} {e}^{- z} dz$$

is the Gamma function when a>0. Theoretically, determines the degradation trajectory and nonlinearity, while determines the scale of the distribution, which stretches or compresses the interval of the probability density function. Let v(t) be a non-decreasing, right-continuous, real-valued function when t>0, and the Gamma process at time t has the following properties: 1) x(t+Δt)−x(t)□Ga(v(t+Δt)−v(t),u), where Δt>0. According to the properties of the Gamma distribution, the mean of x(t+Dt)−x(t) is [v(t+Dt)−v(t)]u, and the variance is [v(t+Dt)−v(t)]u². The distribution of x(t+Dt)−x(t) describes the transfer function of the degradation state over time. 2) x(t) has independent increments, meaning that for any given monitoring time 0<t₁<t₂< . . . <∞, the corresponding degradation state increments Dκ(0,t₁), Dκ(t₁,t₂), . . . are independent random variables.

Due to material properties and manufacturing tolerances, each device exhibits a unique degradation pattern, even among devices of the same type. This variability across devices is referred to as device-to-device heterogeneity. Theoretically, v(t) determines the nonlinearity of the degradation trajectory and can be replaced by either an empirical or physical degradation model. The parameters in v(t) are modeled as device-specific random variables to capture the variance among devices, while the parameter in v(t) is denoted as θ, and it is assumed that θ□N(μ_{θ}, Σ_{θ}). Any individual device can be viewed as a sample from the overall population distribution. Assuming there are m devices in the historical population, and without loss of generality, based on the property of independent increments, the PDF of the degradation state increment Δx(t) for a specific device indexed by i can be developed as follows:

$$f ( {Dx}_{i} ( t ) ) = \frac{1}{uG ( {Dv}_{i} ( t ) )} {( \frac{{Dx}_{i} ( t )}{u} )}^{{Dv}_{i} ( t ) - 1} exp ( - \frac{{Dx}_{i} ( t )}{u} ) \qquad ( 2 )$$

Here, Dκᵢ(t)=xᵢ(t+Dt)−xᵢ(t) and Dvᵢ(t)=vᵢ(t+Dt)−vᵢ(t) represent the degradation increment and the shape parameter of device i at time t respectively, vᵢ(t)=v(t;θᵢ), and θᵢ denotes the individual-specific parameter of device i.

By introducing a noise term into the measurement function of the state-space model, measurement noise is taken into account. For the device i, the measurement equation is given as:

$${y}_{i} ( t ) = {x}_{i} ( t ) + {ε}_{i} ( t ) \qquad ( 3 )$$

Where yᵢ(t) represents the observed measurement, xᵢ(t) is the true underlying degradation state, and εᵢ(t) denotes the measurement noise, which follows a normal distribution with zero mean and variance σ². It is assumed that the noise at different time steps is mutually independent. Equations (2) and (3) serve as the state transition equation and the measurement equation, respectively, forming the state-space model.

In the embodiment of this application, the EM algorithm is utilized to process the accelerated degradation dataset and obtain the initial parameter estimates of the Gamma state-space model, including the following steps:
S104: Determine the state transition model parameters and noise parameters to be estimated based on the Gamma state-space model of each electronic device;
S105: Apply the particle filtering and smoothing algorithm to the historical degradation measurement datasets of the electronic devices, obtaining smoothed particle sets;
S106: Construct the log-likelihood function of the unknown parameters based on the smoothed particle sets, and determine the expected value of the log-likelihood;
S107: Estimate the unknown parameters based on the expected log-likelihood, thereby obtaining the initial model with estimated parameters.

The processor performs steps S104 to S107 to accomplish the parameter estimation of the offline model.

Specifically, assume that the historical degradation dataset contains m devices, each of which operates from deployment until failure. Throughout their operation, degradation signals are recorded at non-periodic and intermittent intervals. These degradation signals are used for estimating the parameters of the state-space model. Two key challenges must be addressed during the model parameter estimation phase: 1) The parameters θ={θ_{1:m},λ,u,σ²} of the established state-space model are unknown and require appropriate statistical estimation methods to infer them based on the historical degradation dataset. 2) The state transition equation of the Gamma state-space model is nonlinear, which poses challenges for accurate degradation state estimation. Traditional linear filtering techniques, such as Kalman filtering, are inadequate for handling such complex nonlinear systems. Therefore, Monte Carlo-based nonlinear filtering techniques are required to accurately estimate the degradation states.

Due to the presence of measurement noise, the true degradation state of the device is unobservable, and the state transition equation has a complex form. Therefore, the Particle Filtering (PF) method is employed to extract the true degradation state of the device. The PF method provides a numerical solution to the recursive Bayesian equations through Monte Carlo simulation. It models the state transition equation as a first-order Markov process and performs state estimation based on the state transition and observation models. PF has been widely applied in practice, especially for nonlinear systems or situations where analytical models are difficult to establish. Without loss of generality, the state transition and measurement equations are defined as follows:

$${x}_{k} = f ( {x}_{k - 1} ) + {w}_{k} \qquad ( 4 )$$

$${y}_{k} = h ( {x}_{k} ) + {v}_{k}$$

Where Here, xₖ is the hidden state to be estimated, yₖ is the measurement at time k, and wₖ and vₖ represent the process noise and measurement noise, respectively.

The Markov process is characterized by an initial distribution p(x₀) and a transition equation p(xₜ|xₜ₋₁). The posterior PDF p(xₖ|y_{1:k}) can be represented by a set of N particles

$${\{ {x}_{k}^{i} \}}_{t = 1}^{N} ,$$

wherein the corresponding weights

$${\{ {w}_{k}^{t} \}}_{i = 1}^{N}$$

are computed based on the conditional likelihood of each particle given the current observation. The posterior PDF at time k can be approximated as:

$$p ( {x}_{k} \vert {y}_{1 : k} ) \approx {\sum }_{i = 1}^{N} {w}_{k}^{i} δ ( {x}_{k} - {x}_{k}^{i} ) \qquad ( 5 )$$

where δ(⋅) represents the Dirac delta function, and y_{1:k} is the noise measurement sequence, and y_{1:k}={y₁, y₂, . . . , yₖ}. The weights

$${w}_{k}^{i}$$

can be recursively updated using methods such as importance sampling. The particle set is drawn from the prior PDF, and the prior PDF typically serves as the proposal distribution:

$$q ( {x}_{k}^{i} \vert {x}_{k - 1}^{i} , {y}_{1 : k} ) = p ( {x}_{k}^{i} \vert {x}_{k - 1}^{i} ) \qquad ( 6 )$$

The importance weights for the particles can be recursively updated according to the following formula:

$${w}_{k}^{i} ∝ {w}_{k - 1}^{i} \frac{p ( {y}_{k} \vert {x}_{k}^{i} ) p ( {x}_{k}^{i} \vert {x}_{k - 1}^{i} )}{q ( {x}_{k}^{i} \vert {x}_{k - 1}^{i} , {y}_{1 : k} )} \qquad ( 7 )$$

where

$$p ( {x}_{k}^{i} \vert {x}_{k - 1}^{i} )$$

is the importance density used for generating particles. Finally, the particle weights can be normalized as:

$${w}_{k}^{i} = \frac{{w}_{k}^{i}}{{\sum }_{i = 1}^{N} {w}_{k}^{i}} \qquad ( 8 )$$

A potential issue in the above algorithm is the particle degradation problem. The weights of the particles are updated recursively, and it is possible for the importance of particles with large weights to continue increasing, while the importance of particles with small weights keeps decreasing. In this case, only a few particles in the particle set significantly impact the distribution, a phenomenon known as particle degeneration. Particle degeneration can lead to wasted computational resources and cause the computation to converge to a local optimum. To solve this problem, a resampling algorithm is introduced. The resampling algorithm works by re-sampling particles based on their weights after the weight normalization step. The probability of a particle being selected is proportional to its normalized weight. This approach allows the random elimination of some particles with small weights, while particles with larger weights are duplicated multiple times. After resampling, the number of particles remains the same, N. In this application, to reduce computational load, basic importance sampling particle filtering is used to estimate the degradation state.

Assume that the degradation processes of m devices are collectively monitored, where the monitoring time sequence for the i-th device is t_{i,0}<t_{i,1}< . . . t_{i,n}_{ᵢ}; and the degradation measurement sequence is y_{i,0}<y_{i,1}< . . . y_{i,n}_{ᵢ}. The particle set obtained by the PF algorithm at time j is denoted as

$$\{ {x}_{i , j}^{1} , {x}_{i , j}^{2} , … {x}_{i , j}^{N} \} ,$$

with corresponding weights

$$\{ {w}_{i , j}^{1} , {w}_{i , j}^{2} , … {w}_{i , j}^{N} \} .$$

The particle filter approximates the posterior distribution by considering only the observations up to the current time. In the historical degradation dataset, the degradation data from the time of device activation until failure are all known. To fully utilize the observation information, after completing the forward particle filtering step, backward particle smoothing is applied in this application to further improve the accuracy of the health state estimation. The particle set at time j obtained from the forward particle filtering is denoted as

$${\{ {w}_{i , j}^{k} , {x}_{i , j}^{k} \}}_{i = 1}^{N} .$$

Initially, the smoothed particle set is set to be the same as the filtered particle set, and the number of smoothed particles is the same as that of the filtered particles. The smoothed particle set is denoted as

$${\{ {w}_{i , j}^{k} , {s}_{i , j}^{k} \}}_{i = 1}^{N} .$$

The weight of the backward smoothed particles can be computed as follows:

$${w}_{i , j \vert j + 1}^{k} = {w}_{i , j}^{k} \cdot f ( {s}_{i , j + 1}^{k} \vert {x}_{i , j}^{k} ) \qquad ( 9 )$$

The weight

$${w}_{i , j}^{k}$$

represents the weight of the k-th particle of the i-th device at time j obtained by the PF algorithm. The weight

$${w}_{i , j \vert j + 1}^{k}$$

represents the weight that has been corrected using the observation information at time j+1 through the particle smoothing technique.

It is important to note that the degradation state estimation is performed under the assumption that the model parameters Θ are known. Typically, when the observation values are known, model parameters can be obtained by maximizing the likelihood function. However, in this case, the effect of observation noise is considered, as noisy observations do not represent the true degradation state and cannot be directly used in maximum likelihood estimation. Therefore, the EM algorithm is adopted to estimate the parameters of the Gamma state-space model. Given the degradation measurements

$${\{ {y}_{i , 0} , {y}_{i , 1} , … {y}_{i , {n}_{i}} \}}_{i = 1}^{m}$$

of m historical devices and the true degradation state

$${\{ {x}_{i , 0} , {x}_{i , 1} , … {x}_{i , {n}_{i}} \}}_{i = 1}^{m} ,$$

the log-likelihood function of the unknown parameter Θ can be expressed as:

$$\begin{matrix}log ( L ( θ ) ) = log ( {\prod }_{i = 1}^{m} f ( {x}_{i , 1 : {n}_{i}} , {y}_{i , 1 : {n}_{𝔩}} \vert θ ) ) \\ = log ( {\prod }_{i = 1}^{m} f ( {y}_{i , 1 : {n}_{i}} \vert {x}_{i , 1 : {n}_{i}} , θ ) \cdot f ( {x}_{i , 1 : {n}_{i}} \vert θ ) ) \\ = log ( {\prod }_{i = 1}^{m} f ( {y}_{i , 1 : {n}_{i}} \vert {x}_{i , 1 : {n}_{i}} , θ ) ) + log ( {\prod }_{i = 1}^{m} f ( {x}_{i , 1 : {n}_{i}} \vert θ ) )\end{matrix} \qquad ( 10 )$$

where ƒ(y_{i,1:n}_{ᵢ}|x_{i,1:n}_{ᵢ}) represents the PDF of the degradation observations given the true degradation state, which is solely dependent on the measurement noise, and ƒ(x_{i,1:n}_{ᵢ}) represents the PDF of the true degradation state, which depends solely on the parameters in the state transition equation. The expectation of the log-likelihood can be decomposed as:

$$E ( log L ( Θ ) ) = E ( log ( f ( {y}_{i , 1 : {x}_{i}} \vert {x}_{i , 1 : {n}_{i}} , {Θ}_{1} ) ) ) + E ( log ( f ( {x}_{i , 1 : {n}_{i}} \vert {Θ}_{2} ) ) \qquad ( 11 )$$

where Θ₁=σ² represents the noise parameters, and Θ₂={θ_{1:m},λ,u} represents the state transition model parameters. The above expression can be further derived as:

$$\begin{matrix}E ( log ( f ( {y}_{i , 1 : {n}_{i}} \vert {x}_{i , 1 : {n}_{i}} , {θ}_{1} ) ) ) = E ( log ( {\prod }_{i = 1}^{m} {\prod }_{j = 1}^{{n}_{i}} f ( {y}_{i , j} \vert {x}_{i , j} , {θ}_{1} ) ) ) \\ = E ( {\sum }_{i = 1}^{m} {\sum }_{j = 1}^{{n}_{i}} log ( \frac{1}{\sqrt{2 π {σ}^{2}}} exp \\ ( - \frac{{( {y}_{i , j} - {x}_{i , j} )}^{2}}{2 {σ}^{2}} ) ) ) \\ = {\sum }_{i = 1}^{m} {\sum }_{j = 1}^{{n}_{i}} ( - \frac{1}{2} log ( 2 π {σ}^{2} ) - \frac{1}{2 {σ}^{2}} ( {y}_{i , j}^{2} - \\ 2 E ( {x}_{i , j} ) {y}_{i , j} + E ( {x}_{i , j}^{2} ) ) )\end{matrix} \qquad ( 12 )$$

$$E ( log ( f ( {x}_{i , 1 , {n}_{i}} \vert {Θ}_{2} ) ) ) = E ( {\sum }_{i = 1}^{m} log ( f ( {Dx}_{i , 1 , {n}_{i}} \vert {Θ}_{2} ) ) ) = E ( {\sum }_{i = 1}^{m} {\sum }_{j = 1}^{{n}_{i}} log ( f ( {Dx}_{i , j} \vert {Θ}_{2} ) ) ) = {\sum }_{i = 1}^{m} {\sum }_{j = 1}^{{n}_{i}} ( - log G ( {Dv}_{i , j} ) - \frac{E ( {Dx}_{i , j} )}{u} + ( {Dv}_{i , j} - 1 ) E ( log ( {Dx}_{i , j} ) ) - {Dv}_{i , j} log u ) \qquad ( 13 )$$

where Dκ_{i,j}=xᵢ(t_{i,j+1})−xᵢ(t_{i,j}), Dv_{i,j}=vᵢ(t_{i,j+1})−vᵢ(t_{i,j}), and the expected related terms can be computed using the particles and their weights obtained from particle smoothing. Specifically, they can be calculated using the following formulas:

$$\{ \begin{matrix}E ( {x}_{i , j} ) = \frac{1}{N} {\sum }_{k = 1}^{N} {s}_{i , j}^{k} \\ E ( {x}_{i , j}^{2} ) = \frac{1}{N} {\sum }_{k = 1}^{N} {( {s}_{i , j}^{k} )}^{2} \\ E ( {Dx}_{i , j} ) = \frac{1}{N} {\sum }_{k = 1}^{N} ( {s}_{i , j}^{k} - {s}_{i , j - 1}^{k} ) \\ E ( log ( {Dx}_{i , j} ) ) = \frac{1}{N} {\sum }_{k = 1}^{N} log ( {s}_{i , j}^{k} - {s}_{i , j - 1}^{k} )\end{matrix} \qquad ( 14 )$$

This allows for the calculation of the expected log-likelihood function. Then, optimization algorithms can be used to maximize equation (14) to obtain the noise parameters and state transition model parameters. The EM algorithm is an iterative process in which the parameters estimated in each round are used for particle filtering and smoothing to obtain the true health states. The obtained true health states are then used to maximize the expectation function.

In the embodiment of this application, step S20 includes the following specific execution process:

S201: The initial parameter estimates are used as the initial values for the particle set, generating parameter particles.

S202: Using the kernel smoothing-based particle filtering algorithm, the parameter particles are shrunk towards the mean, obtaining the first particle parameters.

S203: Random noise is added to the first particle parameters to obtain the second particle parameters.

S204: Based on the first and second particle parameters, the updated particle parameters are obtained.

S205: Using the real-time monitoring data of the field operation devices and the updated particle parameters, the true health state data of each device is generated.

S206: The EM algorithm is used to process the true health state data, obtaining the updated parameters of the initial model, and the updated initial model is then used to process the true health state data to obtain accelerated degradation information of the electronic device.

The processor performs steps S201 to S206 to achieve online model parameter updates.

In the embodiment of this application, step S204 includes the following specific execution process:

S2041: Based on the function expressions of the first and second particle parameters, the expression for the parameter state transition equation is determined.

S2042: Based on the expression for the parameter state transition equation, the updated particle parameters are calculated.

The offline estimated parameters obtained above represent the degradation characteristics of the accelerated failure experiment dataset. However, due to differences in the operating environment of field-operated devices compared to the accelerated failure experiment environment, the degradation paths of the devices vary with changes in operating conditions. Additionally, the heterogeneity between devices further exacerbates the differences in degradation paths. As a result, models built based on the accelerated failure experiment dataset cannot be directly applied to predict the RUL of field-operated devices. To achieve the adaptive update of the model from the accelerated failure environment to the field operating environment, this application proposes a state and parameter joint estimation method based on kernel smoothing particle filtering. This method not only accurately estimates the degradation state of field-operated devices but also enables online updating of model parameters, ensuring that the model can dynamically adapt to field operating conditions. It is important to note that when performing degradation modeling, the individual parameters θ in the model are treated as random variables, and θ~N(μ_{θ}, Σ_{θ}). The sample mean and sample covariance of the offline estimated parameters are considered as the estimates of μ_{θ} and Σ_{θ}. For field-operated device p, the individual model parameters θₚ can be regarded as samples drawn from the distribution N(μ_{θ}, Σ_{θ}). As the degradation state monitoring data of the device p accumulates, the kernel smoothing particle filtering method continuously updates the individual parameters θₚ, realizing the adaptive adjustment of the parameters and effectively reflecting the actual degradation state of the field-operated devices.

Kernel smoothing particle filtering (KS-PF) is essentially an enhancement of the PF method. The idea of enhanced particle filtering is to treat the model parameters as elements of the state vector estimated by PF and to introduce artificial evolution to address the particle degeneracy problem. The state transition equation for the parameter θ can be expressed as:

$${θ}_{p , j + 1}^{k} = {θ}_{p , j}^{k} + ζ \qquad ( 15 )$$

where

$$ζ ∼ N ( 0 , {σ}_{A N}^{2} I )$$

is the artificial noise,

$${θ}_{p , j}^{k}$$

is the k-th parameter particle vector at time t_{p,j} of device p. This method is rarely used in practice because artificial noise is difficult to determine. When a smaller value of

$${σ}_{AN}^{2}$$

is used, the parameter particles will converge to the true value very slowly and fail to address the particle degeneracy problem. On the other hand, using a larger value of

$${σ}_{AN}^{2}$$

can prevent the parameter particles from converging to the true value. To overcome this challenge, this application considers a combined method of kernel smoothing and particle filtering. The evolution of parameter particles is achieved through two steps, the first of which is contraction, and the first particle parameter can be expressed as:

$${\tilde{θ}}_{p , j}^{k} = \sqrt{1 - {s}^{2}} {θ}_{p , j}^{k} + ( 1 - \sqrt{1 - {s}^{2}} ) {\overline{θ}}_{p , j} \qquad ( 16 )$$

where θ̅_{p,j} is the mean of the particle set

$${θ}_{p , j}^{1 : N} ,$$

s is the kernel parameter. The contraction step forces the parameter particles to move toward the mean, with the degree of contraction controlled by s. The larger the value of s, the stronger the contraction towards the mean, while a smaller s results in less contraction. The second step is the perturbation, where the second particle parameter is represented as:

$${θ}_{p , j + 1}^{k} = {\tilde{θ}}_{p , j}^{k} + ξ , ξ ∼ N ( 0 , {s}^{2} {V}_{p , j} ) \qquad ( 17 )$$

where V_{p,j} is the variance of the particle set

$${θ}_{p , j}^{1 : N} .$$

The perturbation step involves adding random noise to the parameter particles, thereby enhancing particle diversity. Furthermore, a special setup for the variance of the random noise s²V_{p,j} ensures that the variance of the parameter particles remains unchanged after the contraction and perturbation steps. This PF variant is referred to as KS-PF. Based on equations (16) and (17), the state transition equation for the parameters can be derived as:

$${θ}_{p , j + 1} \vert {θ}_{p , j} ∼ N ( \sqrt{1 - {s}^{2}} {θ}_{p , j} + ( 1 - \sqrt{1 - {s}^{2}} ) {\overline{θ}}_{p , j} , {s}^{2} {V}_{p , j} ) \qquad ( 18 )$$

In the embodiment of the present application, Step S30 includes the following specific execution processes:

S301: Model the failure threshold as a random variable that follows a normal distribution, where the mean and variance of the random variable are calculated using a historical failure dataset, and determine the marginal survival function of each electronic device based on the updated initial model.”

S302: Based on the survival function, use the Gauss-Hermite quadrature method to approximate the marginal survival function and obtain the lifetime probability density function of the electronic device under the current degradation state.

S303: Based on the lifetime probability density function of the electronic devices, the current accelerated degradation information, and the randomized failure threshold, calculate the RUL of each electronic device.

In the embodiment of the present application, step S301 includes the following specific process:

S3011: Based on the updated initial model, determine the PDF of the shape parameter degradation increment under the updated particle parameters. The PDF of the shape parameter degradation increment is a function of the failure threshold.

S3012: Based on the PDF of the shape parameter degradation increment, determine the survival function for each of the electronic devices driven by the Gamma process.

S3013: Integrate the survival function with respect to the failure threshold to obtain the marginal survival function for each of the electronic devices.

In this embodiment, the processor realizes the online estimation of the RUL of the electronic devices by executing Steps S301 to S303.

Considering that different devices may reach different threshold values when failure occurs, this application incorporates the uncertainty of the failure threshold into the prediction model. When the degradation state x(t) exceeds the threshold x_{F}, it is considered that the device has failed. The threshold x_{F} is modeled as a random variable that follows a normal distribution, i.e.,

$${x}_{F} \sim N ( {μ}_{F} , {σ}_{F}^{2} ) .$$

The mean μ_{F} and variance

$${σ}_{F}^{2}$$

can be calculated using the actual failure times of devices from the offline historical dataset. Let the number of devices in the training dataset be represented as m, and the failure threshold dataset be represented as

$${\{ {F}_{i} \}}_{i = 1}^{m} .$$

By using the sample mean and sample variance as estimates, the estimated mean and variance of the failure threshold are:

$${μ}_{F} = \frac{1}{m} {\sum }_{i = 1}^{m} {F}_{i} , {σ}_{F}^{2} = \frac{1}{m - 1} {\sum }_{i = 1}^{m} {( {F}_{i} - {μ}_{F} )}^{2} \qquad ( 19 )$$

The duration from the current monitoring time t_{p,n}_{ₚ} to the failure moment is regarded as the RUL of the device at time t_{p,n}_{ₚ}. Since for a Gamma degradation process, the degradation at each time point is a random variable, and the failure threshold is also considered a random variable, the device's lifetime T_{F} is a random variable as well, influenced by multiple sources of uncertainty. Once the parameter updates for the field-operating devices have been completed using the KS-PF algorithm, the RUL of the device can be predicted. For simplicity, ƒ(Dκ(t);θ_{p,n}_{ₚ}) is written as ƒ(Dκ(t)), where ƒ(Dκ(t);θ_{p,n}_{ₚ}) represent the probability density function of the degradation increment Dκ(t) under the updated parameters θ_{p,n}_{ₚ}. Then, the survival function of the device driven by the Gamma process can be written as:

$$P ( {T}_{F} > {t}_{p , {n}_{p}} + Dt \vert {T}_{F} > {t}_{p , {n}_{p}} , x ( {t}_{p , {n}_{p}} ) , {x}_{F} ) P ( Dx ( t ) < {x}_{F} - x ( {t}_{p , {n}_{ρ}} ) \vert x ( {t}_{p , {n}_{p}} ) , {x}_{F} ) = {\int }_{0}^{{x}_{F} - x ( {t}_{p , {n}_{p}} )} f ( Dx ( t ) \vert x ( {t}_{p , {n}_{p}} ) , {x}_{F} ) d Dx ( t ) = \frac{1}{G ( Dv ) ( t ) )} {\int }_{0}^{\frac{{x}_{F} - x ( {t}_{p} , {n}_{p} )}{u}} {z}^{Dv ( t ) - 1} exp ( - z ) dz = \frac{G ( Dv ( t ) , \frac{{x}_{F} - x ( {t}_{p , {n}_{p}} )}{G ( Dv ( t ) )} )}{G ( Dv ) ( t ) )} \qquad ( 20 )$$

where z is the integration variable and does not have physical meaning.

$$G ( a , x ) = {\int }_{0}^{z = x} {z}^{a - 1} {e}^{- z} dz$$

is the lower incomplete Gamma function when x≥0 and a>0. t_{p,n}_{ₚ} is the predicted time of the device p, x(t_{p,n}_{ₚ}) represents the health state of the device p at time t_{p,n}_{ₚ}, Dν(t) refers to the shape parameter increment.

Based on Equation (20), the marginal survival function obtained by integrating over x_{F} can be expressed as:

$$P ( {T}_{F} > {t}_{p , {n}_{p}} + Dt \vert {T}_{F} > {t}_{p , {n}_{p}} , x ( {t}_{p , {n}_{p}} ) ) = \int P ( {T}_{F} > {t}_{p , {n}_{p}} + Dt \vert {T}_{F} > {t}_{p , {n}_{p}} , x ( {t}_{p , {n}_{p}} ) , {x}_{F} ) p ( {x}_{F} ) {dx}_{F} \qquad ( 21 )$$

Where p(x_{F}) is PDF of the failure threshold x_{F}. Given that Equation (21) does not have a closed-form solution, we can approximate it using the Gauss-Hermite quadrature method. When the failure threshold's PDF is differentiable, the conditional probability density function of the device's lifetime, given the current degradation state, can be derived as follows:

$$f ( t = {T}_{F} \vert x ( {t}_{p , {n}_{p}} ) , {T}_{F} > {t}_{p , {n}_{p}} ) = \frac{\partial }{\partial t} [ \frac{G ( Dv ( t ) , \frac{{x}_{F} - x ( {t}_{p , {n}_{p}} )}{u} )}{G ( D ) v ( t ) )} ] = \frac{\partial }{\partial \tilde{v}} [ \frac{G ( \tilde{v} , \frac{{x}_{F} - x ( {t}_{p , {n}_{p}} )}{u} )}{G ( D ) v ( t ) )} ] {\vert}_{\tilde{v} = Dv ( t )} {Dv}^{′} ( t ) = \frac{{v}^{′} ( t )}{G ( v ( t ) - v ( {t}_{p , {n}_{p}} ) )} \cdot {\int }_{\frac{{x}_{F} - x ( {t}_{p , {n}_{p}} )}{u}}^{∞} ( ln ( z ) - ψ ( v ( t ) - v ( {t}_{p , {n}_{p}} ) ) ) {z}^{v ( t ) - v ( {t}_{p , {n}_{p}} ) - 1} {e}^{- z} dz \qquad ( 22 )$$

where

$${Dv}^{′} ( t )$$

is derivative of Dν(t) and the digamma function ψ(a)=∂ log G(a)/∂a is the derivative of the logarithm of the Gamma function.

At the prediction time t_{p,n}_{ₚ}, the degradation state estimated by the KS-PF algorithm is represented by a set of degradation particles. Given the estimated degradation state particles, denoted as

$${x}_{p , {n}_{p}}^{1 : N} ,$$

and the model parameters

$${Θ}_{p , {n}_{p}} = \{ {θ}_{p , {n}_{p}} , λ , u , {σ}^{2} \}$$

obtained from the KS-PF algorithm, based on equation (22), the lifetime PDF of the p-th device under the condition of observing the degradation state y_{p,1:n}_{ₚ} can be derived as follows:

$$f ( t = {T}_{F} \vert {y}_{p , 1 : {n}_{p}} , {T}_{F} > {t}_{p , {n}_{p}} ) = \frac{1}{N} {\sum }_{k = 1}^{N} \frac{{v}^{′} ( t )}{G ( v ( t ) - v ( {t}_{p , {n}_{p}} ) )} \cdot {\int }_{\frac{{x}_{F} - {x}_{p , {n}_{p}}^{k}}{u}}^{∞} ( ln ( z ) - ψ ( v ( t ) - v ( {t}_{p , {n}_{p}} ) ) ) {z}^{v ( t ) - v ( {t}_{p , {n}_{p}} ) - 1} {e}^{- z} dz \qquad ( 23 )$$

The effect of this application is verified using an accelerated failure data set of Insulated-Gate Bipolar Transistors (IGBTs).

### 1. Dataset Introduction

In this application, power cycling tests were conducted on 8 IGBT test samples, which comprehensively reflect the degradation behavior of IGBTs under accelerated failure conditions. The experiment involved four test conditions, and the detailed parameters are shown in Table 1. Here, Tⱼₘₐₓ represents the maximum junction temperature during the experiment, tₒₙ and t_{off} are the junction temperature changes during heating and cooling, respectively, and DTⱼ is the durations of heating and cooling. For each test condition, two devices were tested. The aging process was accelerated by thermal stress generated through the cyclic switching on and off of the power cycling current. During the test, the on-state saturation voltage V_{CE} of each cycle was recorded to represent the degradation state of the device. The increase in V_{CE} is considered one of the key features of IGBT degradation, reflecting the performance degradation trend of the device under long-term stress.

TABLE 1
IGBT Test Conditions and Number

| | DTⱼ | Tⱼₘₐₓ | tₒₙ and |
|---|---|---|---|
| Test Conditions | (K) | (° C.) | t_{off} (s) |
| 1 | 100 | 150 | 1.5 |
| 2 | 50 | 150 | 1.5 |
| 3 | 100 | 125 | 1.5 |
| 4 | 100 | 150 | 20 |

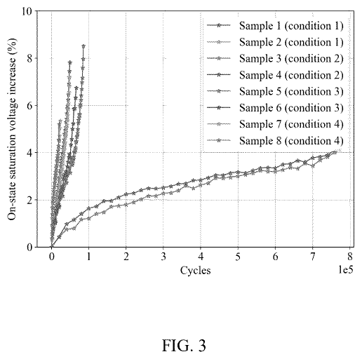

For simplicity, the four test conditions are represented by numbers, and the test conditions, actual failure cycles, and growth percentages of V_{CE} of the 8 IGBT test devices are shown in Table 2. FIG. 3 illustrates the degradation paths of each sample, with the endpoints of the trajectories representing the actual failure cycles of the devices. This chapter develops an adaptive remaining useful life prediction algorithm based on this dataset, providing a solution for IGBT reliability management in practical application scenarios.

TABLE 2
The actual number of failure cycles and the degradation
signal value at the failure moment of the IGBT sample.

| | | True Failure | Increase |
|---|---|---|---|
| Sample | Test | cycles | percentage |
| number | conditions | (kcycles) | of V_{CE} |
| 1 | 1 | 49 | 7.8 |
| 2 | 1 | 48 | 7.2 |
| 3 | 2 | 760 | 4.0 |
| 4 | 2 | 772 | 4.1 |
| 5 | 3 | 85 | 8.5 |
| 6 | 3 | 66 | 6.7 |
| 7 | 4 | 23 | 5.3 |
| 8 | 4 | 20 | 5.2 |

The degradation process of the IGBT can be modeled using a physical degradation model, in which the parameters have specific physical meanings. The variation of the on-state saturation voltage V_{CE} during the IGBT degradation process can be expressed as:

$${DV}_{CE} = \frac{{i}_{c} ρ}{2} [ \frac{1}{2 c} + \frac{ω}{π h} ( \frac{{b}^{2}}{{b}^{2} - {c}^{2}} ln ( \frac{b}{c} - \frac{1}{2} ) ) ] - \frac{{i}_{c} ρ}{2} [ \frac{1}{2 {c}_{0}} + \frac{1}{π h} ( \frac{{b}^{2}}{{b}^{2} - {c}_{0}^{2}} ln ( \frac{b}{{c}_{0}} - \frac{1}{2} ) ) \qquad ( 24 )$$

where i_{c} is the collector current, ρ is the resistivity, c is the equivalent radius of the bond wire contact area, c₀ is the initial value of c, h is the thickness of the aluminum metallization layer, b is its equivalent radius, and w is the factor accounting for the increase in resistivity caused by the reconstruction of the reactive metallization layer.

In the physical model of V_{CE} variation, the unknown parameters to be estimated include c₀, k₁~k₅, and b, which can be categorized into two groups based on their dependency on test conditions. The first group consists of individual-specific parameters θ={k₁~k₅}, which vary with the test conditions. The second group includes population-level parameters λ={c₀,b}, which are independent of the test conditions. As shown in FIG. 3, although the degradation of all samples follows the physical model defined by Equation (24), the degradation trajectories differ significantly among samples. In particular, due to the relatively mild test conditions, Samples 3 and 4 exhibit much longer failure times than the others. In degradation modeling, such differences are captured by the variations in the individual-specific parameters within the model.

### 2. Degradation Modeling and Model Parameter Estimation

During operation, IGBT devices undergo continuous degradation, which is modeled using a Gamma state-space model. Considering that the mean of the Gamma process at time t is u·v(t), where u is the scale parameter and is time-invariant, the aforementioned physical model is integrated into v(t) as prior knowledge to enhance the performance of the degradation model. The unknown parameters in the state-space model are k₁~k₅ and c₀,b,u,σ². It is assumed that θ={k~k₅} follows a multivariate random distribution with mean μ_{θ} and covariance Σ_{θ}, in order to account for variations in operating conditions and device heterogeneity.

The power cycling dataset includes four test conditions, with two samples tested under each condition, totaling eight devices. To simulate the difference between the accelerated degradation testing environment and actual operating conditions, two devices under a specific test condition are removed from the degradation dataset during the offline estimation phase. These two devices are then treated as field-operating devices, mimicking real-world scenarios by continuously collecting their degradation signals and performing RUL prediction. The purpose of this approach is to exclude information related to the actual operating conditions from the historical degradation dataset, thereby constructing a prediction model that better aligns with practical application needs. This setup also serves to provide stronger validation for the effectiveness of subsequent model updates.

The EM algorithm is executed to estimate the individual parameters

$${\{ {k}_{1 , i} \sim {k}_{5 , i} \}}_{i = 1}^{6}$$

and the population parameters c₀,b,u,σ². Subsequently, the same mean μ_{θ} and sample covariance Σ_{θ} are calculated based on

$${\{ {k}_{1 , i} ∼ {k}_{5 , i} \}}_{i = 1}^{6} ,$$

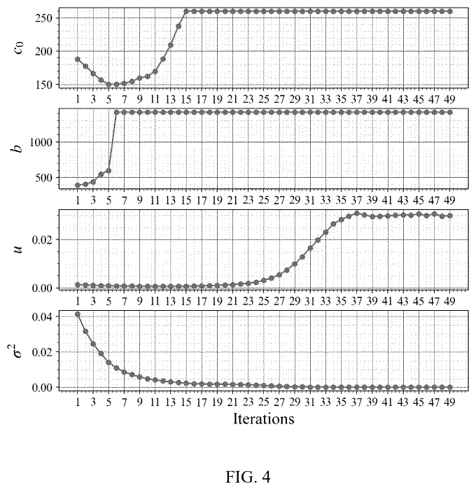

and used as the mean and covariance matrix of θ. During the experiment, Sample 5 is randomly selected as the field-operating device. The convergence process of the population parameters estimated offline is shown in FIG. 4. As observed from the figure, all parameters converge within 49 iterations. Among them, parameter u exhibits the slowest convergence, indicating that estimating u is the most complex. Upon analysis, this is because u, as the scale parameter in the Gamma process, scales the shape parameter and also influences the variance of the Gamma process. Its contribution to the degradation trajectory is coupled with the magnitude of the shape parameter, and its contribution to the stochasticity of the degradation state at each time point is coupled with the measurement noise. This makes u a complex parameter to estimate, hence the slower convergence.

### 3. Model Parameter Update

Given a test device, the individual parameters θ within the model are updated based on its state monitoring data, thereby tailoring the prediction model to the specific device. In this application, the condition monitoring (CM) data collection process is simulated by assuming that the degradation signals of the test device are only known up to the current prediction time point. The parameters obtained from the offline estimation phase via the EM algorithm are used as the initial parameters. Then, the degradation state of the field-operating device is estimated using the KS-PF algorithm described above, while simultaneously updating the individual parameters in the offline-estimated model. Devices 1 and 3 are used as examples to illustrate the predicted degradation paths at different prediction points during the model update process, demonstrating the adaptability and effectiveness of the proposed method.

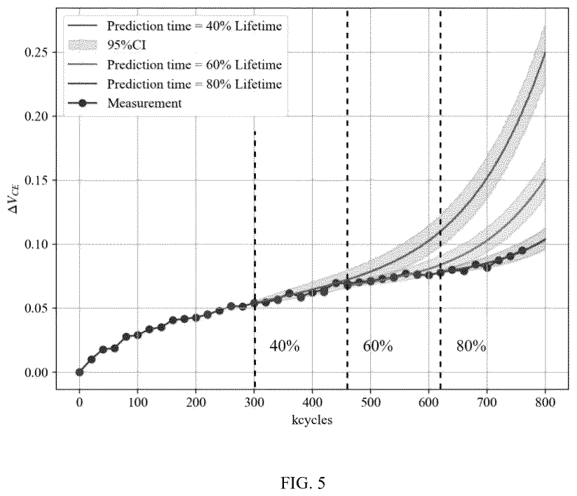

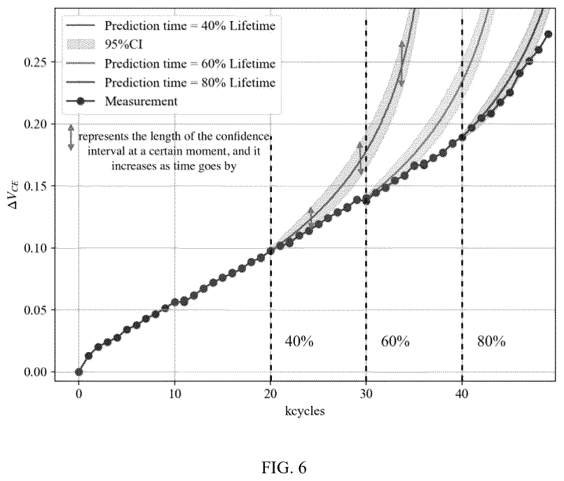

Using the KS-PF-updated models at different time points, the predicted degradation paths for Device 1 and Device 3 are plotted in FIGS. 5 and 6. The prediction time points are selected at 40%, 60%, and 80% of the device's total lifespan, representing the early, middle, and late stages, respectively. The 95% confidence intervals shown in the figures stem from time-related uncertainty. Since each increment of a Gamma process is inherently random, the future degradation states are estimated by randomly generating 1000 Gamma increments at each time point. The 97.5th and 2.5th percentiles of these samples are used to construct the 95% confidence interval for the predicted degradation trajectory. At the prediction points corresponding to 40% and 60% of the device's lifetime, there are noticeable deviations between the predicted and actual degradation paths. This discrepancy arises because the parameters obtained during the offline estimation process reflect the overall characteristics of the historical dataset. However, the degradation paths of Device 1 and Device 3 differ from those of the training data. At these earlier time points, the limited available condition monitoring data provides insufficient information to significantly adjust the offline model, making accurate prediction difficult. As the prediction time increases and more real-time degradation data from the field-operating devices is collected, the model becomes increasingly adapted to the actual operational environment. This trend is evident in the results at the 80% lifespan prediction point, where the predicted degradation path closely aligns with the true trajectory. This demonstrates the effectiveness of the proposed algorithm in leveraging field data to dynamically update the model trained offline.

### 4. RUL Prediction Result Analysis

Typically, the failure criterion of an IGBT is defined based on the percentage increase in its on-state saturation voltage. Since the physical model adopted in this study describes the increase in saturation voltage, the failure threshold—modeled as a random variable—can be translated into a threshold for voltage increment by multiplying it with the initial voltage of the test sample. If the initial voltage of a given IGBT device is denoted as V₀, then the parameters μ_{F} and

$${σ}_{F}^{2}$$

of the failure threshold distribution should be rescaled as μ_{F}·V₀ and

$${σ}_{F}^{2} \cdot {V}_{0}^{2} .$$

A total of 100 samples are drawn from distribution

$$N ( {μ}_{F} , {σ}_{F}^{2} )$$

to serve as the failure thresholds for calculating the RUL.

Using the method described above, RUL prediction is then performed. Each of the eight devices under four operating conditions is used as a test device in turn. The RUL prediction is conducted when each device reaches approximately 80% of its total lifetime. It is important to note that all condition monitoring data for the devices are collected at discrete time points. As a result, it is not possible to perform RUL prediction exactly at the 80% lifetime mark. For example, for Device 1, the actual prediction time corresponds to 81.6% of its total lifespan.

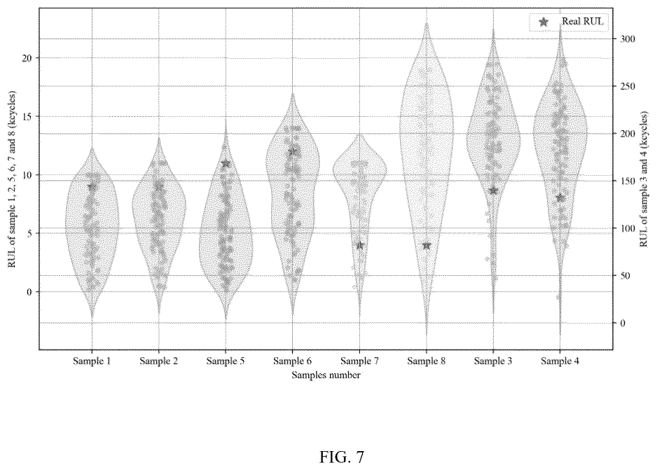

FIG. 7 illustrates the RUL prediction results for different test devices at 80% of their lifespan. Each scatter point in the figure corresponds to a predicted RUL value based on a sampled failure threshold. The violin plots describe the overall distribution of the predicted RUL values, while the red asterisks indicate the actual RULs of the devices. As shown, the actual RUL consistently falls within the predicted RUL distribution range, demonstrating that the proposed method is capable of accurate RUL prediction in the later stages of device life, even while accounting for the uncertainty in the failure threshold.

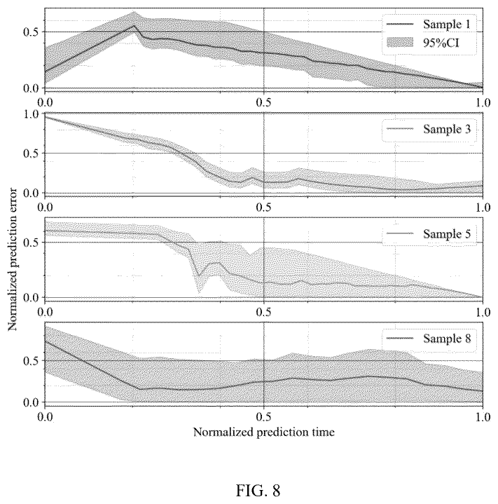

This application adapts the prediction model from an accelerated degradation test environment to a real-world operational environment by updating the individual-specific parameters. The adaptation process occurs continuously as more condition monitoring data is collected from the field-deployed devices. To validate the effectiveness of this update process, the relationship between prediction error and the prediction start time is analyzed. Both the prediction start time and prediction error are normalized with respect to each device's lifetime. FIG. 8 shows how prediction error evolves during the prediction process across different devices. It can be observed that prediction errors are relatively large in the early stages, but decrease significantly as the prediction progresses.

To further evaluate the necessity and effectiveness of the model's adaptive update mechanism, Table 3 compares the prediction accuracy before and after applying the adaptive mechanism. The results indicate that, without the adaptive mechanism, prediction accuracy remains relatively low and does not improve over time. In contrast, with the adaptive mechanism, prediction accuracy improves steadily with time, reaching a value of 0.965 at a normalized prediction time of 0.8.

TABLE 3
Comparison of Prediction Accuracy Before
and After Adopting the Adaptive Mechanism

| Normalized prediction time | 0 | 0.2 | 0.4 | 0.6 | 0.8 |
|---|---|---|---|---|---|
| Prediction Accuracy | 0.508 | 0.508 | 0.508 | 0.508 | 0.508 |
| Before Adopting the | | | | | |
| Adaptive Mechanism | | | | | |
| Prediction Accuracy | 0.408 | 0.694 | 0.774 | 0.881 | 0.965 |
| Before Adopting the | | | | | |
| Adaptive Mechanism | | | | | |
| Percentage Improvement | / | 36.6 | 52.4 | 73.4 | 90.0 |
| in Prediction Accuracy | | | | | |
| Before and After | | | | | |
| Adopting the Adaptive | | | | | |
| Mechanism (%) | | | | | |

Through case validation, the following conclusions can be drawn:

This application achieves high-precision RUL prediction of electronic devices under field operating conditions by adaptively adjusting the predictive model from the accelerated life testing environment to the field operating environment. Specifically, the prediction error decreases as the prediction time progresses, and when predictions are made at 80% of the device's lifespan, the prediction accuracy reaches 0.965. This method overcomes the challenge of using predictive models trained in accelerated life testing environments for field applications through the adaptive update of the model. It holds significant practical and engineering application value.

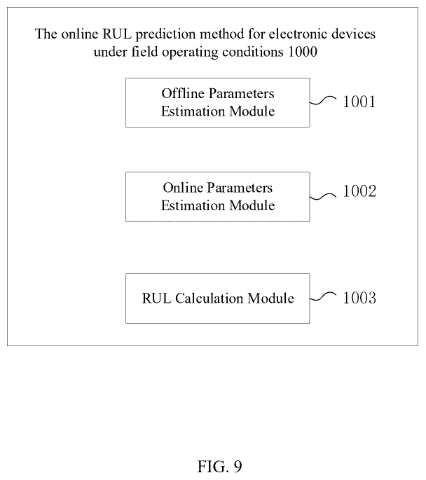

With reference to FIG. 9, based on the aforementioned embodiment, this application further proposes an online RUL prediction system 1000 for electronic devices under field operating conditions. The system includes:

Offline Parameter Estimation Module 1001: Used in the offline phase to model the degradation process of electronic devices using the Gamma stochastic process. The physical prior model is embedded as the shape parameter in the Gamma stochastic process, resulting in a Gamma state-space model. The EM algorithm is applied to the pre-acquired accelerated degradation experimental dataset to obtain the initial model after parameter estimation. Online Parameter Update Module 1002: In the online phase, real-time monitoring data from field operating devices is input into the state and parameter joint estimation algorithm based on KS-PF. This module dynamically updates the accelerated degradation information of the electronic devices and the parameters of the initial model. Lifetime Estimation Module 1003: Based on the updated initial model, the randomized failure threshold distribution, and the accelerated degradation information, this module calculates the RUL of each electronic device.

In addition, based on the aforementioned embodiment, this application also proposes a computer-readable storage medium, which includes instructions. When executed on a computer, these instructions enable the computer to perform the RUL online prediction method for electronic devices under field operating conditions, as provided in any of the preceding embodiments.

Additionally, based on the aforementioned embodiment, this application also proposes an electronic device, which includes at least one processor, a memory, and an input/output unit. The memory stores a computer program, and the processor executes the computer program stored in the memory to perform the RUL online prediction method for electronic devices under field operating conditions as provided in any of the preceding embodiments.

The above are only preferred embodiments of this application and do not limit the scope of the claims of this application. Any equivalent structural or process transformations made using the content of the description and drawings in this application, or direct or indirect application in other related technical fields, are likewise included within the patent protection scope of this application.

What is claimed is:

1. An online remaining useful life (RUL) prediction method for electronic devices under field operating conditions, characterized by comprising:
At offline stage: modeling the degradation process of electronic devices using a Gamma stochastic process, in which a physics-informed prior model is embedded as the shape parameter of the Gamma process to form a Gamma state-space model. An expectation-maximization algorithm is applied to a pre-acquired accelerated degradation dataset to estimate model parameters and obtain the initial model.
At online stage: feeding real-time monitoring data from field-operating devices into a kernel smoothing particle filter for joint state and parameter estimation. This yields dynamically updated accelerated degradation information and updated parameters of the initial model.
Based on the final updated model, the randomized failure threshold distribution, and the accelerated degradation information, the remaining useful life of each electronic device is calculated.

2. In the embodiment of the present application, the method for online remaining useful life prediction of electronic devices under field operating conditions as described in claim 1 is characterized in that, in the offline phase, a Gamma stochastic process is used to model the degradation process of the electronic devices, and a physics-informed prior model is embedded as the shape parameter into the Gamma stochastic process to obtain a Gamma state-space model, including:
Obtaining the probability density function (PDF) of the Gamma stochastic process, wherein the PDF includes the shape parameter, scale parameter, and measurement noise parameter, with the shape parameter containing the degradation state increment;
Representing the degradation state increment as a random variable related to the individual device, thereby obtaining the probability density function of the individual device, and determining the true degradation state of the electronic device based on the individual device's PDF;
Determining the Gamma state-space model for each electronic device based on the true degradation state with added Gaussian noise.

3. In the embodiment of the present application, the method for online prediction of the remaining useful life of electronic devices under field operating conditions as claimed in claim 1, characterized in that an initial model with estimated parameters is obtained by processing pre-acquired accelerated degradation experiment datasets using the Expectation-Maximization (EM) algorithm, comprising:
Determining the unknown parameters to be estimated based on the Gamma state-space model of each electronic device, wherein the unknown parameters include state transition model parameters and noise parameters;
Performing particle filtering and smoothing algorithms on the historical degradation measurement datasets of the electronic devices obtained in advance to obtain smoothed particle sets;
Determining the log-likelihood function of the unknown parameters based on the smoothed particle sets, and determining the expected value of the log-likelihood based on the log-likelihood function;
Estimating the unknown parameters based on the expected log-likelihood to obtain the initial model with estimated parameters.

4. The online remaining useful life prediction method for electronic devices under field operating conditions according to claim 1, characterized in that in the joint state and parameter estimation algorithm based on kernel smoothing particle filtering, the real-time monitoring data of the device under field operation is input to obtain the dynamically updated accelerated degradation information and the initial model parameters of the electronic device, comprising:
Taking the parameter particle vector at any given time as the parameter particle;
Applying the kernel smoothing particle filtering algorithm to shrink the parameter particles toward their mean to obtain the first particle parameters;
Adding random noise to the first particle parameters to obtain the second particle parameters;
Updating the particle parameters based on the first and second particle parameters;
Generating the actual health state data of each device based on the real-time monitoring data of the field operating device and the updated particle parameters;
Using the EM algorithm to process the actual health state data to obtain the updated initial model parameters, and using the updated initial model to process the actual health state data to obtain the accelerated degradation information of the electronic device.

5. The online RUL prediction method for electronic devices under field operating conditions according to claim 4, wherein obtaining the updated particle parameters based on the first particle parameters and the second particle parameters comprises:
Determining the expression of the parameter state transition equation according to the functional expressions of the first particle parameters and the second particle parameters;
Calculating the updated particle parameters based on the expression of the parameter state transition equation.

6. The online prediction method for the RUL of electronic devices under field operating conditions as described in claim 1, characterized in that the remaining lifetime of each electronic device is calculated based on the final updated model, the randomized failure threshold distribution, and the accelerated degradation information, including:
Determining the marginal survival function of each electronic device based on the updated initial model;
Obtaining the marginal survival function and approximating it using the Gauss-Hermite quadrature method to obtain the lifetime probability density function of the electronic device under the current degradation state;
Calculating the remaining lifetime of each electronic device based on its lifetime PDF, current accelerated degradation information, and randomized failure threshold.

7. The online prediction method for RUL of electronic devices under field operating conditions, as described in claim 6, is characterized in that, based on the updated model, the marginal survival function of each electronic device is determined, including:
Determining the PDF of the shape parameter degradation increment under the updated particle parameters based on the updated model, where the PDF of the shape parameter degradation increment is a function of the failure threshold;
Determining the survival function of each electronic device driven by the Gamma process based on the PDF of the shape parameter degradation increment;
Integrating the survival function with respect to the failure threshold to obtain the marginal survival function of each electronic device.

8. An online RUL prediction system for electronic devices under field operating conditions, characterized by the following steps:
Offline parameter estimation module, used during the offline phase to model the degradation process of the electronic device using a Gamma random process, embedding the physical prior model as the shape parameter into the Gamma random process to obtain the Gamma state-space model. The EM algorithm is applied to process the pre-acquired accelerated degradation experimental dataset, yielding the initial model with estimated parameters.
Online parameter update module, used during the online phase, where the real-time monitoring data of the field-operated device is input into the joint state and parameter estimation algorithm using kernel smoothing particle filtering, resulting in dynamically updated accelerated degradation information for the electronic device and parameters of the initial model.
Lifetime estimation module, used to calculate the remaining lifetime of each electronic device based on the final updated initial model, randomized failure threshold distribution, and the accelerated degradation information.

9. A computer-readable storage medium, characterized in that it includes instructions, which, when executed on a computer, cause the computer to perform the online prediction method of the RUL of an electronic device under field operating conditions as described in any one of claims 1 to 7.

10. An electronic device, characterized in that the electronic device comprises:
at least one processor, memory, and input/output unit;
wherein the memory is used to store a computer program, and the processor is used to invoke the computer program stored in the memory to execute the online prediction method of the remaining life of an electronic device under field operating conditions as described in any one of claims 1 to 7.
